(19) United States
(12) Patent Application Publication
(10) Pub. No.: US 2011/0258679 A1
(43) Pub. Date: Oct. 20, 2011

(54) Method and System for Accessing Network Feed Entries

(75) Inventors: Todd Kaplinger, Raleigh, NC (US); Steven D. Ims, Apex, NC (US); James Michael Bonanno, Raleigh, NC (US); Aaron J. Tarter, Apex, NC (US)

(73) Assignee: International Business Machines Corporation, Armonk, NY (US)

(21) Appl. No.: 12/760,607

(22) Filed: Apr. 15, 2010

(51) Int. Cl. H04L 29/06; G06F 17/00

(52) U.S. Cl. 726/1; 726/3

(57) ABSTRACT

A security mechanism for an application level protocol used to publish and edit web resources is extended to enable enforcement of a security policy on feed entries. The security mechanism ensures that only a certain class of privileged users can perform create, read, update and/or delete (CRUD) actions on feed entries, and it provides a uniform methodology for determining security access controls for resources. The techniques described herein enable selectively display of feed entries while at the same time maintaining a single document source for the privileged users.

### BACKGROUND OF THE INVENTION

1. Technical Field

This disclosure relates generally to network data feeds and, in particular, to techniques for enforcing security policy on feed entries.

2. Background of the Related Art

Web feeds allow software programs to check for updates published on a web site. To provide a web feed, a site owner may use specialized software (e.g., a content management system) that publishes a list (or “feed”) of recent articles or content in a standardized, machine-readable format. The feed can then be downloaded by web sites that syndicate content from the feed, or by feed reader programs that allow users of Internet-accessible devices to subscribe to the feeds and view their content.

The name “Atom” refers to a pair of related standards concerning web feeds. The Atom Syndication Format is an XML language used for web feeds, and the Atom Publishing Protocol (AtomPub or APP, as described in Internet RFC 5023) is an HTTP-based protocol for creating and updating web resources. Because it is based on HTTP, APP is subject to the same security considerations found in Section 15 of the HTTP protocol, Internet RFC 2616. To address these security threats, the AtomPub Working Group has recommended that security for such feeds can be enforced using conventional techniques, such as running authenticated HTTP under Transport Layer Security (TLS). While securing communication of the Atom document itself in this manner provides some security, it does not provide an appropriate level of protection with respect to individual feed entries being performed by individual users. To address that problem, one approach is to provide a distinct instance of the APP document to each user, but such an approach is not scalable. An alternative is to introduce a proxy as an intermediary to manage feed entry level access controls on individual users, but this approach can be circumvented and thus an unauthorized user may be able to view the complete APP document without permission.

### BRIEF SUMMARY

A security mechanism for an application level protocol (such as Atom) used to publish and edit web resources is extended to enable enforcement of a security policy on feed entries. The security mechanism ensures that only a certain class of privileged users can perform create, read, update and/or delete (CRUD) actions on feed entries, and it provides a uniform methodology for determining security access controls for resources. The techniques described herein enable selectively display of feed entries while at the same time maintaining a single document source for the privileged users.

A machine-implemented method for extending a security model for an application level protocol such as AtomPub (or APP) begins by configuring a URI-based security rule that identifies a feed, user context information, and an authentication type. In response to receiving a URL requesting return of the feed, the URL is filtered against the URI-based security rule to determine access rights to the feed. A response to the URL is then generated based on the access rights so determined. The method may be implemented in a special purpose apparatus that comprises a processor, and computer memory storing computer program instructions executed by the processor to carry out the method steps. Typically, the response generated by the method is a feed entry associated with an entity that has been authenticated according to the authentication type. The access rights comprise a set of actions on a feed entry within the feed, and these actions typically comprise one of the following: create, read (view), update and delete. The user context information in the URI-based security rule typically is one of a user identity, or a group identity.

According to another aspect, a computer program product in a computer readable medium is provided for use in a data processing system to enforce a security policy on a feed entry. The computer program product stores computer program instructions which, when executed by the data processing system perform a method. The method begins by filtering a URL against a URI-based security rule for a user credential indicating permission to perform one of a set of actions on a feed entry within the feed. Based on the filtering, a response to the URL is generated and returned to an authenticated user. That response may be a given feed entry of the feed. The set of actions include create, read, update and delete. Preferably, the user credential is a group identity or a user identity.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a schematic diagram of a known system for user established group-based security for user-created resources in which embodiments of this disclosure may be practiced;

FIG. 2 is an exemplary block diagram of a data processing system in which exemplary aspects of the illustrative embodiments may be implemented;

FIG. 3 is an example APP document where two users (user1 and user2) have provided entries;

FIG. 4 is a relationship table that facilitates a security policy that filters based upon a user attribute, such as username;

FIG. 5 is the example feed of FIG. 3 filtered according to the teachings herein to display an entry associated with just a first user;

FIG. 6 is the example feed of FIG. 3 filtered to display an entry associated with just a second user;

FIG. 7 is a relationship table that facilitates a security policy that filters based upon group membership;

FIG. 8 is a block diagram illustrating an access control mechanism for determining visibility of Atom feed entries according to this disclosure.

### DETAILED DESCRIPTION OF AN ILLUSTRATIVE EMBODIMENT

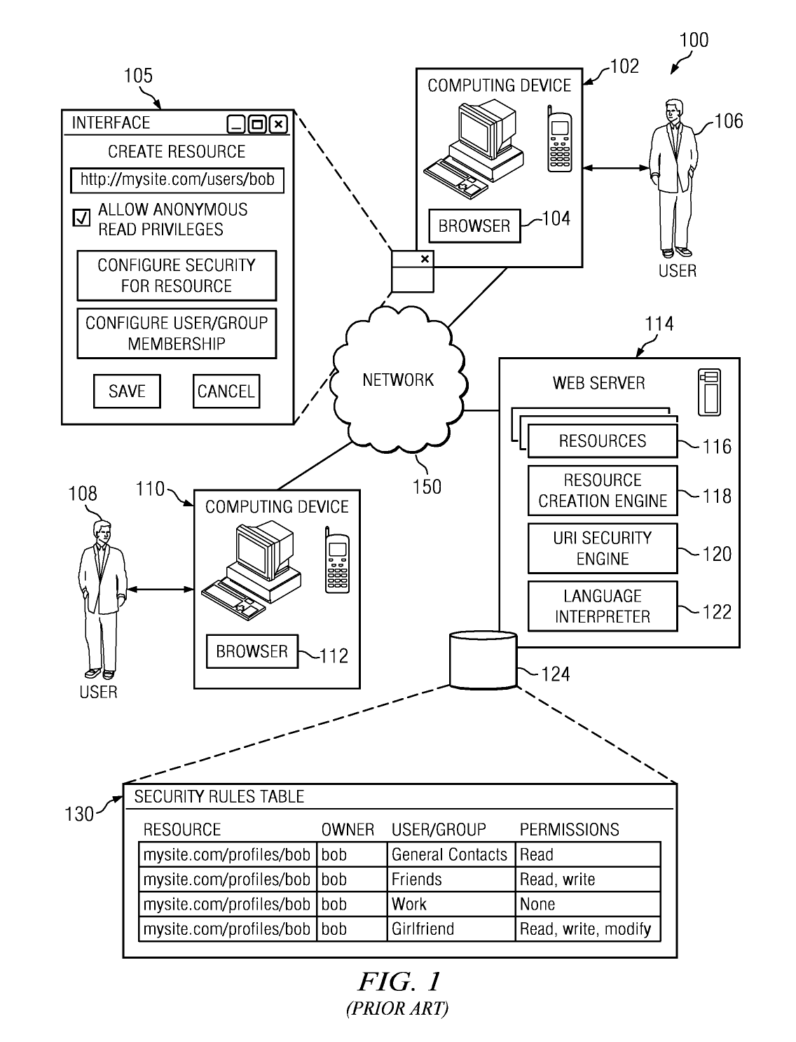

FIG. 1 is a schematic diagram of a known system for user established group-based security for user-created resources in which embodiments of this disclosure may be practiced. It should be appreciated that FIG. 1 is only exemplary and is not intended to assert or imply any limitation with regard to the environments in which aspects or embodiments of the disclosed subject matter may be implemented. Many modifications to the depicted environments may be made without departing from the spirit and scope of the present invention.

The system 100 provides for user-established group-based security for user-created REST-based resources. As used herein and with respect to FIG. 1, Representational State Transfer (REST) refers to a style of software architecture that defines how resources 116 are defined, accessed, and addressed. Typically, a REST resource (e.g., resource 116) is identified by a Uniform Resource Identifier (URI), which then functions as a primary key for the resource. REST interfaces (e.g., interface 105) transmit domain-specific data over HTTP without any requirement for an additional messaging layer, such as SOAP, or session tracking, e.g., via HTTP cookies. Additionally, REST architectures divide application state and functionally into resources 116. All resources 116 can share a uniform interface for a transfer of state between clients and resources 116, and this interface includes a constrained set of well-defined operations, as well as a constrained set of content types. Typically, REST resources use a protocol that is client-server, stateless, cacheable, and layered.

The security system 100 provides a mechanism for user-defined security, which security preferably is added to Web 2.0 content at content creation time. Web 2.0 content refers to content adapted to be created and shared by and among a set of Web users. In system 100, user 106 uses an interface 105 on computing device 102 to interface with a resource creation engine 118 in Web server 114 to create a resource 116. User 106 uses browser 104 to interact with Web server 114 to establish security policies to be applied to the created resource 116 by a URI security engine 120. In particular, the security engine 120 permits user 106 to define different groups, and different permissions to be associated with each group. Further, each user that is able to own a resource 116 may have a user-specific set of groups established. A relationship between an accessing user 108 and a resource owner 106 is used to define which groups and associated group/user permissions apply to a given resource 116. Thus, the URI security engine 120 relies upon semantics of user/group control rather than upon explicit configurations. Permissions are then applied based solely upon a URI of a resource 116 and an identity of a user accessing the resource.

Typically, a resource owner is associated with a URI for a resource. The resource owner can have associated therewith a user-specific relationship matrix associated. A relationship matrix is a data structure that comprises a set of configurable records used to define a group to which an accessing user belongs. For example, groups defined for a URI-identified resource shown in table 130 includes a set of identified groups, which groups are merely representative. Using appropriate interfaces, a user 106 is permitted to establish customized groups, and/or to utilize a set of previously established groups based upon definable criteria. The groups can be based upon groupings established within or defined by other systems, such as a contact management system. Further, a profile accessible by server 114 and specific to users 106 who have created resources can be used for defining groups, and for determining membership within a group.

Once group security has been established, other users 108 access to a given resource 116 is based upon (or enforced by) these settings. As noted above, group membership may depend upon a relationship with an accessing user 108 and a resource owner 106. Therefore, when different users 108 attempt to access a URI-defined resource of server 114 via a browser 112 of computing device 110, different permissions are granted. Permissions can include read, write, update, and delete privileges or subsets and derivatives thereof.

For example from table 130, when “friend” accessing a resource identified as “mysite.com/profiles/bob” may be granted read/write permission, while a person belonging to a Work group may have no privileges. Further, although not shown, different content can be segmented into sub-regions (each identified by a distinct URI), to permit user-provided resources to be more tightly-controlled.

Web server 114 may include any computing device or set of computing devices configured to serve data via network 150. As shown, Web server 114 can include resources 116, resource creation engine 118, URI security engine 120, language interpreter 122, and data store 124. In one embodiment, the resource creation engine 118 and/or URI security engine can be implemented separately from a server process that provides web pages. The URI security engine 120 may implemented within middleware and/or implemented as a Web service provided by a network element communicatively linked to the Web server 114 via network 150. The URI security engine 120 may use any of a variety of encryption techniques to ensure secured data is handled in accordance to user/group based access policies. These techniques may include additional layers of security above the user/group based access policies. For example, users 106, 108 may be required to authenticate themselves using user identifiers and authentication information (e.g., password, a digital certificate, biometric input, etc.) to verify their identity before user/group based permissions for individual resources 116 are applied. The resource creation engine 118 may be an engine used by Web server 114 to allow users to create new resources to add to resources 116. Resource creation engine 118 may provide interfaces, such as interface 105, to users to allow the creation and/or modification of resources.

As noted above, the URI security engine 120 allows the securing of resources 116. When a URI request is sent to Web server 114, URI security engine 120 evaluates security policies stored on data store 124 regarding the requested URI. Security rules table 130 illustrates security policies regarding resources 116. Such rules can relate to the user's associated group and designate read, write, and modify access to resources 116.

The language interpreter 122 can be a component in which can interpret and execute code that is not natively executable. Language interpreter 122 can be used to interpret Web scripts that reside on Web server 114. In some embodiments, URI security engine 120 and resource creation engine 118 can require language interpreter 122. For example, URI security engine 120 can require information in a user's session in which is established with a script being run. Resource creation engine 118 can be created in a language in which requires language interpreter 122 to execute.

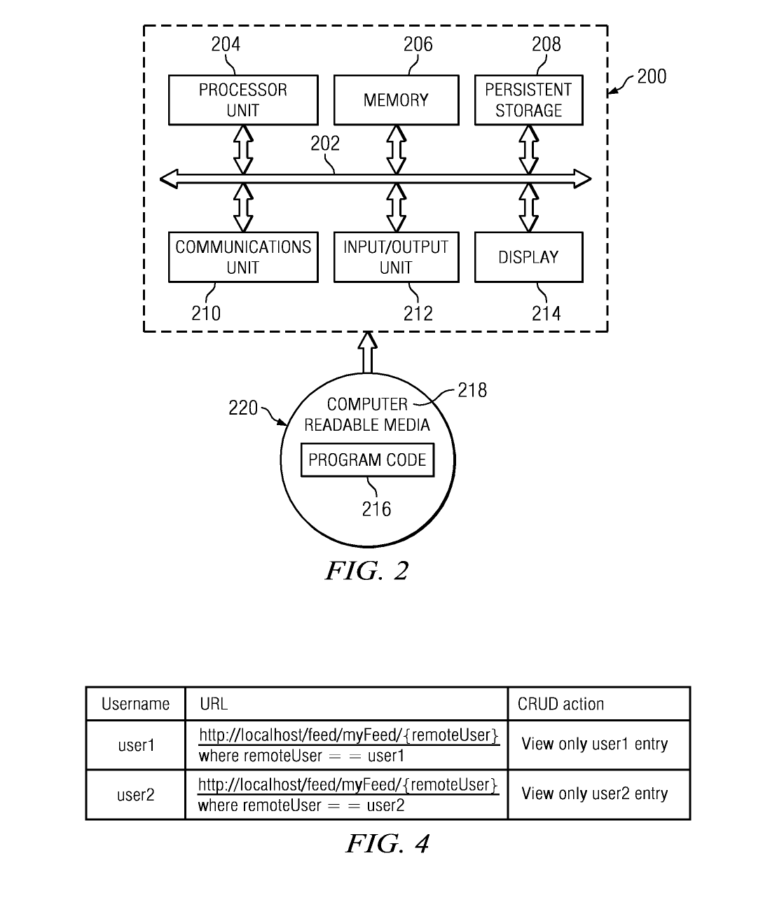

With reference now to FIG. 2, a block diagram of an exemplary data processing system is shown in which aspects of the illustrative embodiments may be implemented. Data processing system 200 is an example of a computer, such as computing device 102 or web server 114 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of the illustrative embodiments may be applied to a multiprocessor data processing system, other than the SMP system mentioned previously, without departing from the spirit and scope of the disclosed subject matter.

According to the teachings of this disclosure, the group-based security system illustrated above in FIG. 1 is extended to provide an enhanced security model for feed-based web resources. Thus, in this disclosure, the resource 116 is a data feed and, in particular, an XML document that is Atom Publishing Protocol (APP)-compliant. In this enhancement, the resource creation engine 118 and the URI security engine 120 of the system of FIG. 1 are implemented as components of an application server that provides for the creation and management of data feeds. Although not meant to be limiting, an illustrative application server that may be used for this purpose is IBM® WebSphere® and its sMash™ development and execution platform. In a representative embodiment, the resource creation engine 118 of FIG. 1 is extended to expose an interface 105 through which a user defines a “security policy” for a data feed. A security policy comprises one or more security rules, wherein a rule has a condition associated therewith. The condition typically is expressed in the form of a URI “/request/path/=˜” argument, where the “=˜” argument is configurable to identify one or more users, groups and/or permissions. In this manner, a user may explicitly configure each feed within an APP document with user-based or group-based security, as well as to associate one or more permissions with respect to the feed. In the context of an APP document, the URI-based permissions typically are “create,” “read,” “update,” and “delete” (CRUD) actions on the feed entry, or subsets and derivatives thereof. The resource creation engine 118 may be used declaratively (by having a user define the URI security rules table 130), or programmatically. The URI security engine 120 of FIG. 1 then is implemented within or in conjunction with a feed processing component of the application server. Upon receipt of a URI, the URI security engine 120 evaluates the security policies stored on data store 124 with respect to the requested URI and provides a response. In particular, the incoming user is mapped against an authenticated user to determine access rights (CRUD actions) to the resource (the feed, or portion thereof). The response is the filtered feed, namely, the feed that results from applying the URI argument to the security policy.

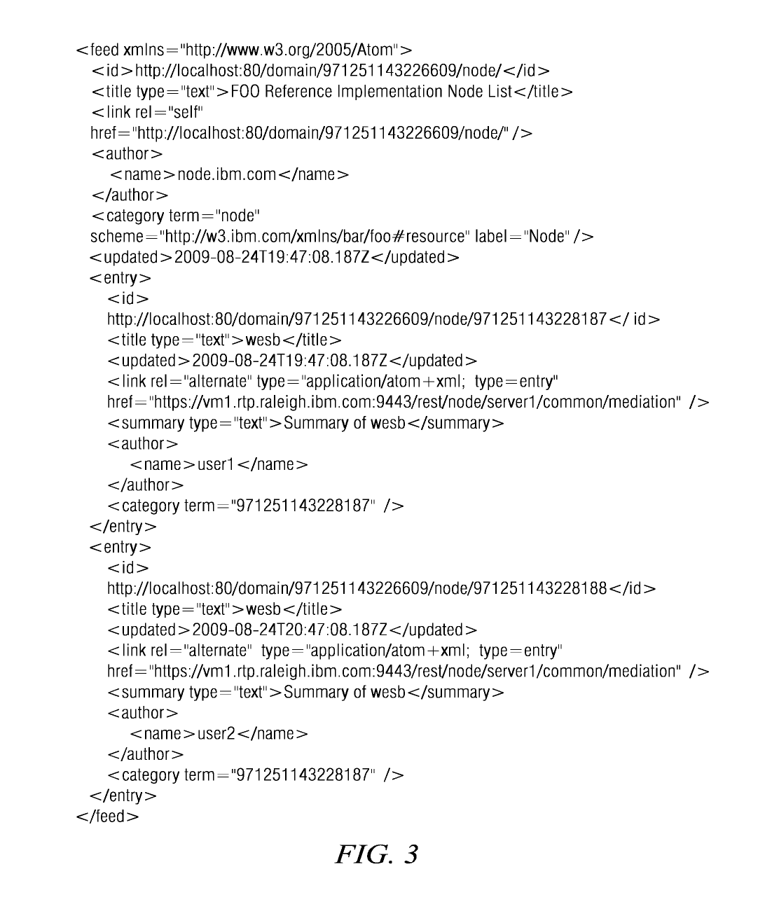

This process can be seen by way of example. FIG. 3 is an example APP document (more generally, a feed) where two users (user1 and user2) have provided entries. The first feed entry is set forth at lines 12-24, and this entry has been authored by a first user (user1). A feed entry is delineated by the <entry> and </entry> tags. The second feed entry is set forth at lines 25-37, and this entry has been authored by a second user (user2). Thus, the entries were created by two distinct users denoted by the author elements. This example is merely for illustration purposes, as a typical feed may contain many more entries with many more authors. As one of ordinary skill in the art will appreciate, the XML shown in FIG. 3 conforms to the Atom Publishing Protocol, as described at RFC 5023.

By leveraging the techniques described herein, it is assumed that a user has used the interface 105 and the associated resource creation engine 118 to define a security policy. As noted above, a security policy comprises one or more security rules that are adapted and constructed to be enforced by the URI security engine implemented as a feed processing component of an application server. Preferably, a URI-based security rule comprises a URI request path, and a set of arguments that include: a feed, user context information, and authentication type. Although the format of the security rule will be implementation-specific, the following is a representative rule that is designed to execute in a WebSphere sMash execution environment:

@include “security/rule.config”{
“conditions”: “(/request/path =~ /feed/myFeed/{remoteUser})”,
“authType” : “Basic”
}

As can be seen, in this example the security policy is implemented by way of an include statement in a configuration file. The name of the feed is “myFeed.” The basic security rule is set forth as a “condition” that is defined in the URI request/path, in this case “/feed/myFeed/{remoteUser}” with an authentication type (“authType”) set to a given value, such as basic authentication (“Basic”). The {remoteUser} is “user context information” that is used by the URI security engine to filter the incoming request, e.g., by username. By including the authentication type in the security policy, the feed entry can be filtered for user credentials (or other authentication tokens) indicating permission to perform one or more given CRUD (create/read/update/delete) actions on a feed entry. Of course, the authentication type and value are merely representative. In this example, the {remoteUser} argument is just a simple user name value. FIG. 4 illustrates a basic relationship table that has been defined with a simple set of filtering options for this example. The relationship table is stored in the data store 124 or other computer memory. As can be seen in the table, these options enable user1 to view his or her feed (but not to view the feed of any other user), and vice versa with respect to user2. Of course, the relationship table illustrated in FIG. 4 is merely representative, as the particular CRUD (or other action) may be varied. By applying the security rule, the system determines what Atom feed entries are visible/editable and by whom.

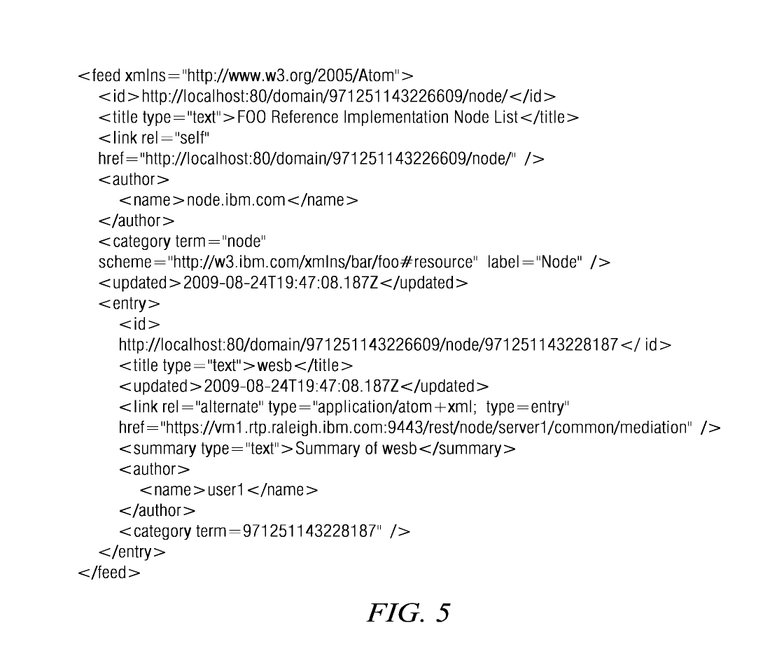

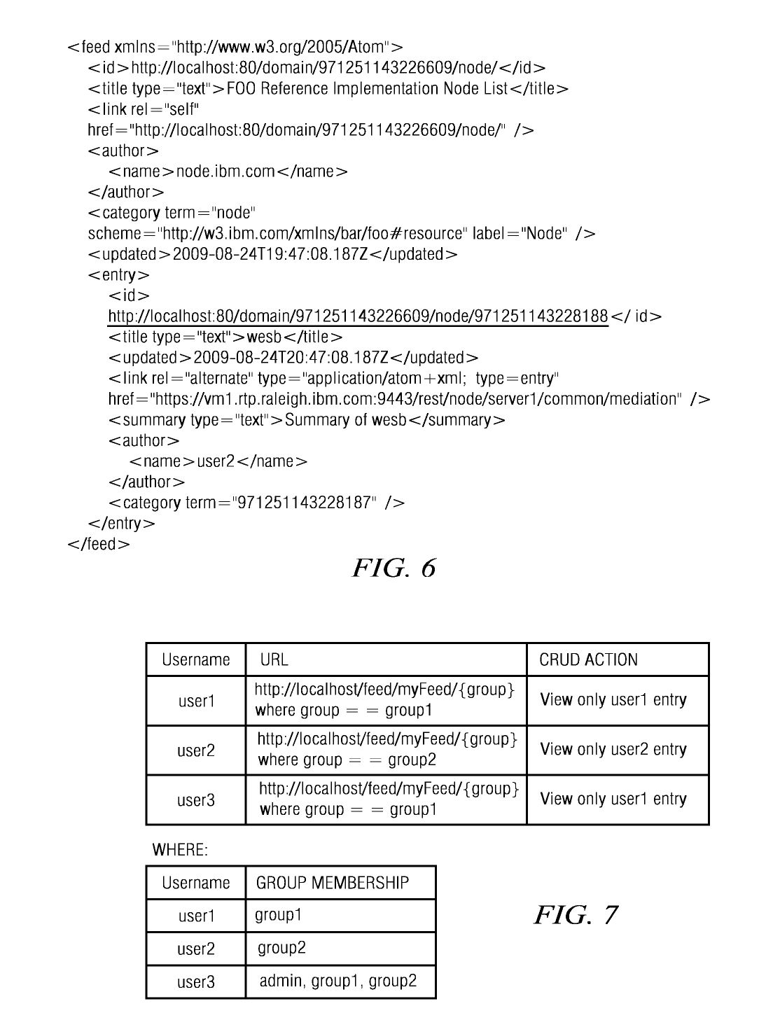

In operation, when the URL http://localhost/feed/myFeed/user1 is received at the URL security engine, the feed myFeed is fetched from the data store 124 or other computer memory and applied against the above-identified security policy. The URL has associated therewith an authentication token (or other identifier indicating a prior authentication), which is typically passed in an HTTP header. If the authentication token associated with the received URL is validated, then the myFeed document (i.e. the document with multiple entries) is filtered according to the relationship table. The result in this case is that user1 can view an XML document with just his or her feed entry, such as illustrated in FIG. 5. Likewise, when URL http://localhost/feed/myFeed/user2 is received at the URL security engine, the feed myFeed is fetched from the data store 124 and applied against the security policy. If the user making the request has been or can be authenticated using the identified authentication mechanism, then myFeed once again is filtered according to the relationship table. The result is that user2 can view an XML document with just his or her feed entry, such as illustrated in FIG. 6. Of course, the feed entry or entries displayed in response to the URL received will depend on the security policy and the relationship table. Likewise, the permitted CRUD action or actions will depend on the specification.

Thus, in a typical use case, a user is authenticated to the application server in a authentication operation and receives a user-specific authentication token or the like. That user-specific token is then passed with the URL that is applied against the URI-based security rule if the token matches that which got generated when the user authenticated initially. If the token passed with the URL does not match the previously-generated token (or other identifier) associated with the previous authentication, the request to access the specific feed entry is denied. The authentication token passed with the URL may be of any type (depending on the nature of the underlying authentication). Generalizing, the token may be considered a “user credential” or a “credential” that provides proof of the prior authentication.

As can be seen above, the above-described technique enables selectively display of feed entries to different authorized users while maintaining a single document feed source (the APP document illustrated in FIG. 3 in the above example scenario). Thus, the disclosed technique enables fine-grained feed entry level access controls on an Atom document in a manner that has not been possible heretofore.

The first embodiment illustrates how a security policy provides filtering of a feed according to a user attribute such as a username. A second embodiment provides a more complex example wherein the security policy provides filtering according to a group membership, such as the following security policy (as might be implemented using an include statement in a WebSphere sMash runtime environment):

@include “security/rule.config”{
“conditions”: “(/request/path =~ /feed/myFeed/{remoteGroup})”,
“authType” : “Digest”
}

As described above, this security policy may be defined in any convenient manner, such as via the interface 105 and the resource creation engine 118. A programmatic policy generator may also be used. The policy is stored in data store 124 or other computer memory. In this example, and with reference to FIG. 7, it is assumed that a relationship table has been defined and is stored in data store 124 or other computer memory. In this example, the filtering is going to be performed based on group membership. Thus, this table associates the username with the “group”-based URI and the filtered CRUD action. In this example, user1 is a member of group1; user2 is a member of group2, and new user3 is a member of an administration group, as well as a member of both group1 and group2. When the URL http://localhost/feed/myFeed/{group} is received, and assuming that the user credential passed with the request matches that which was previously generated, the feed processing component maps the incoming user against the authenticated user's group membership to determine access rights to the resource. In this example, the authentication type is “digest-based” instead of basic (userid and password). Thus, given the relationships set forth in the table shown in FIG. 7, user1 gets to view the XML document shown in FIG. 5, user2 gets to view the XML document shown in FIG. 6, and user3 gets to view the XML document shown in FIG. 5. Once again, the CRUD action or actions permitted will depend on the values in the relationship table.

Although the examples set forth above illustrates username and group membership as the relevant “user context” information within a URI-based security rule, this is not a limitation, as other types of user context data may be included. Other examples include, without limitation, roles, entitlements, domains, IP addresses, and the like. In addition, while the examples illustrate the use of basic and digest-based authentication, this is not a limitation either. Other types of authentication include, without limitation, form-based authentication, OpenID-based authentication, challenge and response-based authentication, and the like.

The above-described approach provides significant flexibility, as individual users may be granted different CRUD permissions with respect to a feed. Certain users or classes or users will be afforded certain specified CRUD rights with respect to feed entries. In this manner, the system provides a uniform methodology for determining security access controls for feed-based resources.

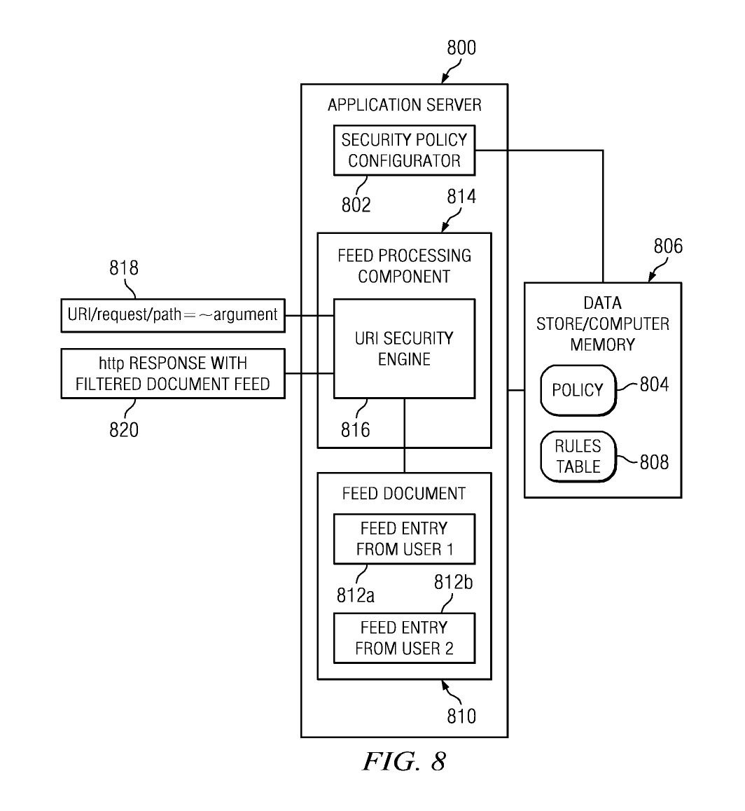

FIG. 8 is a block diagram illustrating the inventive approach generally. According to the described technique, application server 800 executes a security policy configurator 802 by which a security policy 804 is generated and stored in data store 806. A security rules table 808 is also stored in the data store or other computer memory. A feed document 810 comprises a plurality of feed entries 812a-n, at least one of which has been generated by a user/program entity that differs from at least one other user/program entity. The feed document may be stored in the data store or otherwise made available to the application server. It is desired to enforce the security policy 804 against the security rules table. To that end, feed processing component 814 executes URI security engine 816. Upon receiving a URL 818, the URI security engine 816 maps the incoming user against an authenticated user or the authenticated user's group membership as defined in the security rules table to determine access rights to the feed document 810. The URI security engine 816 returns the filtered document 820, typically via an HTTP response. As noted above, this operation takes place if the user credential supplied with the URL matches the credential generated during a previous authentication.

In the embodiments described and illustrated, the web feed is an APP document, namely, a document that is compliant with the Atom Publishing Protocol. The use of an APP document is not a limitation, however, as other Web 2.0 standards may be used to create the source data feed resource. As an alternative feed source, a feed adhering to an RSS standard (Really Simple Syndication, RDF Site Summary, or Rich Site Summary) may be used.

In the context of an APP document, the URI-based permissions are create, read, update, delete (CRUD) actions on the feed entry, or subsets and derivatives thereof, but this is not a limitation either, as any REST-based actions may be implemented.

Further, although the declarative-based (relationship table) approach has been described and illustrated, this is not a limitation either, as the particular users or group membership may be specified programmatically.

One of ordinary skill will appreciate that even more complex security policies may be implemented by further extending the data model and the instance-based URI access control mechanism that has been described. Thus, the particular embodiments described should not be construed as limiting this disclosure as the access rights to the feed document may be enforced upon whatever URI access control mechanism has been specified. Thus, the techniques disclosed herein provide for a uniform extensible methodology for providing robust and scalable, yet fine-grained feed entry level access controls on an Atom or equivalent document.

Without limitation, and as noted above, the security policy and feed processing (URI security) component functions may be implemented in software, as one or more specialized or “particular” machines. The policy evaluation, together with the relationship table (more generally, a data structure), may be implemented in a specialized or “particular” machine, such as an feed entry level access control server. Conventional application server tools and systems, such as WebSphere sMash, may be adapted for this purpose, or the techniques may be implemented in any other convenient manner.

The block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The disclosed subject matter can take the form of an entirely hardware embodiment, an entirely software embodiment or an embodiment containing both hardware and software elements. In a preferred embodiment, the invention is implemented in software, which includes but is not limited to firmware, resident software, microcode, etc.

The disclosed subject matter can take the form of a computer program product accessible from a computer-usable or computer-readable medium providing program code for use by or in connection with a computer or any instruction execution system. For the purposes of this description, a computer-usable or computer readable medium can be any tangible apparatus that can contain or store the program for use by or in connection with the instruction execution system, apparatus, or device.

The medium is tangible, and it can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the disclosed subject matter has been presented for purposes of illustration and description, and is not intended to be exhaustive or limited to the invention in the form disclosed. Many modifications and variations will be apparent to those of ordinary skill in the art. The embodiment was chosen and described to best explain the principles of the invention, the practical application, and to enable others of ordinary skill in the art to understand the invention for various embodiments with various modifications as are suited to the particular use contemplated.

As noted, the techniques described herein may be implemented in or in conjunction with various server-side architectures including simple n-tier architectures, web portals, federated systems, and the like.

An access control mechanism that implements the disclosed techniques may be implemented as a service, or as a standalone machine.

Having described our invention, what we now claim is as follows:

1. A method for enforcing a security policy on a feed entry, comprising:
configuring a URI-based security rule that identifies a feed, user context information, and an authentication type;
in response to receiving a URL requesting return of the feed, filtering the URL against the URI-based security rule to determine access rights to the feed; and
returning a response based on the access rights so determined.

2. The method as described in claim 1 wherein the response is a feed entry associated with an entity that has been previously authenticated according to the authentication type.

3. The method as described in claim 1 wherein the access rights comprise a set of actions on a feed entry within the feed.

4. The method as described in claim 3 wherein the actions include a read.

5. The method as described in claim 1 wherein the user context information is a user identity.

6. The method as described in claim 1 wherein the user context information is a group identity.

7. The method as described in claim 1 wherein the response is a markup language document.

8. The method as described in claim 7 wherein the markup language document is XML and the URL is communicated via HTTP.

9. The method as described in claim 8 wherein the markup language document is an Atom document.

10. A method for enforcing a security policy on a feed, comprising:
filtering a URL against a URI-based security rule for a user credential indicating permission to perform one of a set of actions on a feed entry within the feed; and
returning a response to the URL based on the filtering.

11. The method as described in claim 10 wherein the response consists essentially of a given feed entry in the feed.

12. The method as described in claim 10 wherein the user credential is included in a header.

13. Apparatus, comprising:
a processor; and
computer memory holding computer instructions that, when executed by the processor, perform a method for enforcing a security policy on a feed entry, the method comprising:
configuring a URI-based security rule that identifies a feed, user context information, and an authentication type;
in response to receiving a URL requesting return of the feed, filtering the URL against the URI-based security rule to determine access rights to the feed; and
returning a response based on the access rights so determined.

14. The apparatus as described in claim 13 wherein the response is a feed entry associated with an entity that has been authenticated according to the authentication type.

15. The apparatus as described in claim 13 wherein the access rights comprise a set of actions on a feed entry within the feed.

16. The apparatus as described in claim 15 wherein the actions include a read.

17. The apparatus as described in claim 13 wherein the user context information is a user identity or a group identity.

18. A computer program product in a computer readable medium for use in a data processing system for enforcing a security policy on a feed entry, the computer program product holding computer program instructions which, when executed by the data processing system perform a method, comprising:
filtering a URL against a URI-based security rule for a user credential indicating permission to perform one of a set of actions on a feed entry within the feed; and
returning a response to the URL based on the filtering.

19. The computer program product as described in claim 18 wherein the set of actions include a read.

20. The computer program product as described in claim 18 wherein the user credential is a group identity or a user identity.

21. The computer program product as described in claim 18 wherein the response consists essentially of a given feed entry in the feed.

22. The computer program product as described in claim 18, wherein the computer program instructions are stored in the computer readable medium in the data processing system, wherein the computer program instructions were downloaded over a network from a remote data processing system.

23. The computer program product as described in claim 18, wherein the computer program instructions are stored in the computer readable medium in the data processing system, wherein the computer program instructions are downloaded over a network to a remote data processing system for use in a computer readable medium with the remote system.
